(19) United States
(12) Patent Application Publication
(10) Pub. No.: US 2008/0082362 A1
(43) Pub. Date: Apr. 3, 2008

(54) METHOD FOR LOCATING AND DISPLAYING INFORMATION IN AN INFORMATION SYSTEM OF A MEDICAL FACILITY

(76) Inventor: Sultan Haider, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/863,525

(22) Filed: Sep. 28, 2007

(30) Foreign Application Priority Data
Sep. 29, 2006 (DE) 10 2006 046 319.6

(51) Int. Cl. G06Q 50/00

(52) U.S. Cl. 705/2

(57) ABSTRACT

In a method for locating and for display of information in an information system of a medical facility, in particular a hospital, with a number of input and display apparatuses communicating via a network, input data defining in their entirety at least one procedure to be implemented are linked by the information system with procedure information, a procedure-related user interface is generated dependent on the procedure information, and the user interface is displayed on a stationary or mobile input and display apparatus.

### BACKGROUND OF THE INVENTION

1. Field of the Invention

The present invention concerns a method for locating and displaying information in an information system of a medical facility (in particular a hospital) with a number of input and display apparatuses communicating via a network.

2. Description of the Prior Art

A number of items of information must be administered and made available for specific procedures to be implemented in hospitals or other medical facilities. In the framework of the automation and the electronic storage of data, hospital information systems are known that transfer the information that has conventionally been present on paper into electronically-readable media in, for example, databanks and therein configure this information so that it can be retrieved. Such information can be, for example, data of an electronic patient record, as well as information about medicines that are present in inventory.

Which information is presently needed is determined according to the procedure that is presently to be implemented. Attempts to describe the procedures occurring in a medical facility, in particular in a hospital, are based, for example, on what is known as the treatment path of a patient. Four large procedure groups are initially differentiated, namely the admission of the patient, the diagnosis of the patient, the therapy of the patient and the discharge of the patient. Sub-procedures (for example laboratory findings, image acquisition (CT, MR, . . . ) in the field of diagnosis, etc.) can be associated with each of these groups. Each of these sub-procedures in turn describes further sub-procedures.

A patient to be treated now passes through a treatment path through the medical facility, the treatment path being composed of a series of such different procedures. For example, the patient is initially admitted, assigned to a specific station, explains his or her symptoms to a physician, is directed to different diagnostic devices, the results there are assessed by a physician, a therapy program is suggested, and finally the patient is discharged again from the hospital.

Various procedures during this treatment path of a patient respectively require different information that is made accessible to personnel of the facility. For example, a medical-technical assistant who works at an image acquisition device requires information about the diagnosis that has been posed and thus how the image acquisition device must be set for acquisition. A physician who conducts visits in the individual patient rooms requires specific information about the current state of health of the visited patient, for example his or her current physiological measurement values. The most varied information, partially of an administrative type, partially of a medical type, are also required by a physician for the preparation of a discharge report. Dependent on the procedure, medical personnel accordingly have specific roles for which they are responsible to be sure that the necessary information for implementation of the procedure is acquired.

In known hospital information systems, user interfaces are provided at various input and display apparatuses for obtaining this information. Since a number of items of information must be accessed, usually an extremely complex structure of the user interface results, such that information can be found only with difficulty and substantial effort. Furthermore, user interfaces varying in part at different locations, for example a special user interface for a magnetic resonance apparatus and a special user interface for new admission of a patient into the medical facility. Therefore, medical personnel must be able to work with a number of different, complex user interfaces. It is thus easily possible that relevant or even vital information is not located, or is lost.

A further problem of the complex user interfaces for information systems in medical facilities is their complicated test conditions. Due to the number of parameters for data acquisition, post-processing, measurement processes, etc., highly complex test conditions result, such that tests occupy a great deal of time and are very error-prone.

The complicated search for information by medical personnel in present-day information systems for medical facilities also represents a significant time factor that extends the costs and the duration of the treatment of a patient to a large degree.

### SUMMARY OF THE INVENTION

An object of the present invention is to provide a method that allows a faster location of information (and therewith an acceleration of procedures) in the context of a medical information system is enabled.

This object is achieved in accordance with the invention by a method of the aforementioned type wherein input data defining in their entirety at least one procedure to be implemented are linked by the information system with procedure information, a procedure-related user interface is generated dependent on the procedure information, and the user interface is displayed on a stationary or mobile input and display apparatus.

The invention is based on the insight that the knowledge about the procedures to be implemented essentially entirely determines the required information. Through suitable linking of acquired input data within the information system, it is possible with the inventive method to anticipate the procedure(s) to be implemented and correspondingly to display a simplified user interface that gives the user a faster and simpler access to the actual required information. A faster, simpler and largely less error-prone way to arrive at information required for a procedure is thereby achieved.

Ultimately, the procedure to be implemented is one of the sub-procedures (as described above) that occur in the treatment path of a patient; the procedure thus can be a procedure during any of the admission of a patient, or the diagnosis of a patient, or the therapy of a patient, or the discharge of a patient.

In the inventive method, procedure information is initially determined. For this purpose, input data defining at least one procedure to be implemented are linked in their entirety via by information system. Such input data can include, for example, the spatial position of the apparatus and/or an item of time information, as well as authentication data of a user (in particular his or her qualification) and/or patient-related data (in particular from an electronic patient record). In addition to an input by the user, known devices and methods can be used to acquire such data. For example, at least one part of the input data can be acquired via a radio system. Transponders can relay information about the position of the input and display apparatus, the medical personnel and/or the patient, such that spatial positions can be determined. Furthermore, an electronic card reader system can be provided. For example, medical personnel can be identified via a chip card or an electronic health card can be read via a card reader device provided at an apparatus. RFID (radio-frequency identification) chips can be used as a further example. Alternatively, a scanner for barcodes can be provided at the apparatuses, which scanner can, for example, read barcodes on a wristband of a patient. Input data can also be read from storage devices, for example from an electronic patient record. Naturally, further possibilities to acquire the input data are also conceivable.

The input data now define a procedure to be implemented, or a group of procedures to be implemented, that should be executed by the medical personnel. Some examples of these are as follows. A cardiologist has identified himself or herself at the input and display apparatus of a magnetic resonance device via a chip card, the magnetic resonance device being permanently associated with the input and display apparatus. From the electronic patient record, the system learns that a heart valve problem was determined in a previous examination of this patient, and this problem should be diagnosed in more detail if possible by the magnetic resonance examination. The preceding diagnosis was made by a different physician. From this, the system now determines procedure information, the procedure to be implemented in this case being a magnetic resonance acquisition of the appropriate body region, thus first the correct setting of the magnetic resonance apparatus. Through the user interface that is generated, the physician now receives all information that he or she requires to set the magnetic resonance apparatus. This information is intelligibly prepared for him or her as a cardiologist. Under the circumstances, a specification is also displayed that suggests possible measurement parameters of the magnetic resonance apparatus.

Another example is a physician who is presently located on his or her visiting rounds and carries with him or her a personal, mobile input and display apparatus, for example a pocket PC or a mobile phone. From a localization system, for example a transponder in the mobile apparatus, it can be established that the physician is now located in a specific patient room. From the time it is deduced that this is the physician's regular daily visit. From data of a storage device it is also known that two patients are located in this room, namely patient A and patient B. The procedure is here the visit, via which the cited data can be linked with a corresponding procedure information. For example, the generated user interface hereby offers the physician the selection between patient A and patient B, whereupon the physician accordingly has displayed the information selected from an electronic patient record and required for the visit, for example the current physiological values. If it is furthermore known to the system that the physician is treating only one of the two patients, so the information of that patient can immediately be shown on the input and display apparatus.

A further example is a nurse who has been correspondingly identified and is located in a medicine storage room. There he or she can then retrieve information about the medicines that are present via the user interface. For example, if the nurse scans a barcode on a patient record via a scanner, the system automatically checks whether a medicine prescribed to the patient is currently in stock and where the nurse can find it.

All persons just now described accordingly fulfill specific roles that depend on their position in a treatment path, thus on the procedure to be conducted. The generated user interface enables the relevant information to be located quickly and simply. The general design of the user interface is thereby always kept similar, such that no greater refamiliarization is required than is necessary for the task at hand, and intuitive operation thus is enabled. A number of further possibilities and examples are naturally conceivable as to how a possible procedure or a number of possible procedures can be concluded from input data, and how a user interface via which the relevant information can be retrieved can be constructively generated therefrom.

In an embodiment of the method, the input data and/or the procedure information are stored in a databank. This is reasonable not only for protocol and test purposes, but also for what are called “precedence cases” that can simplify the association of an item of procedure information with input data.

In another embodiment of the invention, at least one trainable and/or knowledge-based system (in particular a neural network) is used for generation of the user interface. In this manner it is possible for the information system to learn from the behavior of the user through information queries, in order to identify the procedures to be implemented and the information that is relevant for these even quicker, more effectively and more simply and to present an improved user interface. User-related or procedure-related data from the past can in particular be taken into account in the generation of the user interface. The system thus learns with each implementation of the method by “observing” which information a user actually selects, where the user is located, with which procedure this information is to be associated, etc. In particular, genetic algorithms and/or statistical analyses and/or Bayesian methods can be used for this analysis.

Values for parameters to be set by a user, in particular measurement parameters, also can be determined with particular advantage and be displayed in the user interface. From the wealth of experience of the past it is known to the information system (and in particular a trainable and/or knowledge-based system) which parameters can ideally lead to a good acquisition of a specific body part to be diagnosed, or in which manner measurement results can be best displayed in order to make the diagnosis easier. This is then reflected in the proposed values for the parameters. In the simplest case, a user then simply just has to confirm these parameters.

The user interface is advantageously, additionally also adapted specific to the user. Every user has his own preferences which the presentation of information or the information selection addresses. In this exemplary embodiment, the behavior of the respective user with regard to the information system is ultimately additionally recorded and analyzed, and from this information it is concluded as to how the user interface can be further adapted. In a rough gradation, a user can be classified, for example, as a new user, an experienced user or a professional user, less information being displayed with progressing degrees of experience. However, an individual user can also be individually considered when, for example, only specific information is required for a specific diagnosis. Only this information is then displayed to that user. Another example is a physician who wants to display exposures from a specific angle and a specific viewing direction for specific clinical investigation (specific pathology). All of these can enter into the generation of the user interface.

In the following a few more examples are cited that present the advantageous use of such a trainable and/or knowledge-based system.

For example, the selection of measurement parameters by medical personnel can be observed and learned. Corresponding values can then be suggested again given similar clinical investigations, thus similar required exposures.

The selection or consideration with regard to an exposure or exposure series with specific pathological findings can likewise be observed and learned. This is particularly meaningful for user-specific user interfaces.

The selection of parameters with the pathological variations that were observed by the medical personnel can also be correlated, particularly in the two cases just cited.

Follow-up examinations, for example, are a good example of this. A first user receives a specific set of information during a first data acquisition, in which set of specific information are comprised a smaller set of relevant information, for example image regions that show a pathological finding. A second user should now implement a follow-up examination, for example further examine only a specific region of the original exposures with another modality. For this purpose, the second user now receives the necessary information that relates to the pathological finding and this is displayed to the second user based on the known preferences of the second user, such that the second user can incorporate it as quickly as possible corresponding to his or her working style. Parameters are additionally known to the system from the past with which a new modality can ideally be controlled and which can be used as specification values in a corresponding mask.

In further embodiment of the invention, an additional adaptation of the user interface by a user can ensue. This should relate not only to, for example, a suitable optical appearance (for example a setting of the colors) but also to which information the user would like to have displayed or not displayed. Such a selection can, for example, also be fed to the trainable and/or knowledge-based system. For example, an experienced physician requires less information to generate a finding than a less-experienced physician. For example, it is possible for the experienced physician to de-select the display of specific information. Further modifications of the user interface by the user are conceivable.

The generation of the user interface can ensue with consideration of parameters that are predeterminable by a user. In this embodiment, it is additionally possible for the user to influence the manner in which the information are linked and thus the manner by which the user interfaces are generated. This can be useful for advanced users.

Various network standards that can be combined with one another can be used for communication of the individual components of the information system. A wired or wireless LAN (local area network) and/or a Bluetooth system and/or an infrared system can be used for communication.

### BRIEF DESCRIPTION OF THE DRAWINGS

FIG. 1 illustrates an example of the structuring of procedures in a hospital.

FIG. 2 schematically shows an inventive information system for a hospital.

FIG. 3 is a flowchart of an embodiment of the inventive method.

FIGS. 4A and 4B are examples for a user interface for a physician's visit.

FIG. 5 is an example for a user interface for a nurse in a medicine storage room.

FIG. 6 is an example of a user interface for the input of parameters for a magnetic resonance apparatus.

### DESCRIPTION OF THE PREFERRED EMBODIMENTS

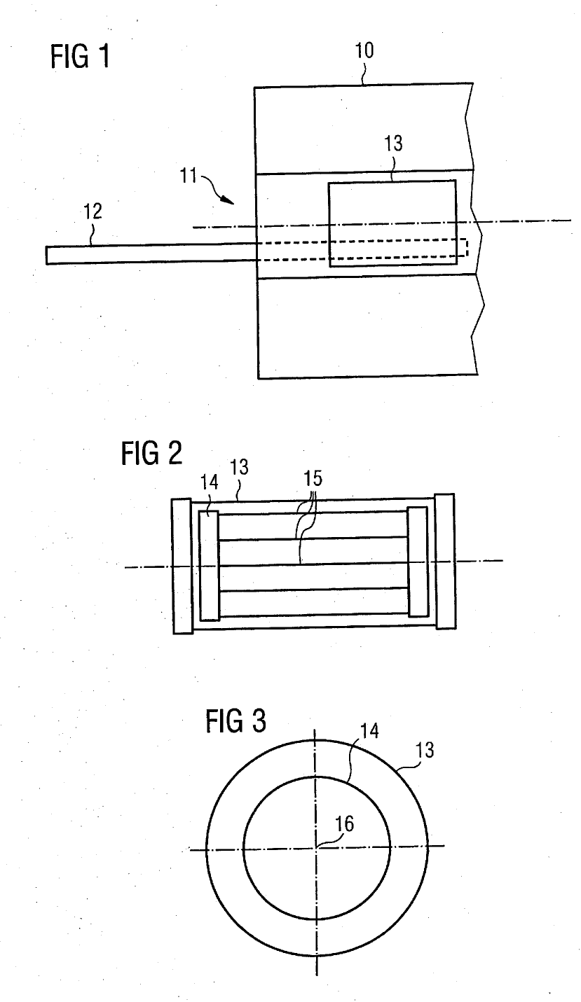

FIG. 1 shows a possible structuring of the procedures in a hospital. The coarsest abstraction level A is divided into the admission 1 of a patient, the diagnosis 2 of a patient, the therapy 3 of a patient and the discharge 4 of a patient. A further abstraction level B shows procedures as examples for the diagnosis 2 associated with the abstraction level A. A diagnosis 2 can thus be implemented using laboratory examinations 5, image acquisitions 6 (for example CT, MR etc.) and further procedures 7 (not listed in detail here). The abstraction level C for the image acquisition 6 is shown in detail below the abstraction level B. This is divided into the patient registration 8, image acquisition 9 and image evaluation 10. Further sub-procedures can be provided for these on a further abstraction level D (not shown in detail).

It should be noted that a medical facility (in particular a hospital) can even be sub-divided into a number of departments for which admission, diagnosis, therapy and discharge respectively form the level of highest abstraction. For example, the division of departments such as the emergency room and station operation are possible.

A patient admitted to the hospital will now undergo various procedures in known his or her treatment path. These procedures are implemented by medical personnel. In order to be able to implement the procedures, the medical personnel require information. The inventive method and the inventive information system are concerned with a fast location and a fast display of such information.

FIG. 2 shows an embodiment of an inventive information system 11. It is essentially controlled by a central server 12, however, a number of servers can also be provided, or a decentralized control can be used. A decision system 13 which, in the inventive method, is responsible for the generation of the user profiles, is implemented in the central server 12. The server 12 additionally has a databank 14 and electronic patient records 15.

The server 12 is networked with a number of input and display apparatuses 17 via communication connections 16. Furthermore, the server 12 communicates with a localization system 18 that determines the position of the mobile input and display apparatuses 17 and possibly also persons within the hospital.

The input and display apparatuses 17 can be stationary apparatuses (for example workstation computers), computers associated with measurement devices or other medical equipment, or mobile apparatuses (for example pocket PCs or phones). Further devices 19 can be associated with the input and display apparatuses 17, for example barcode readers or card readers and many other devices.

In the exemplary embodiment, the inventive method is executed on the server 12, implemented the decision system 13. This comprises a trainable and knowledge-based system 20 and possibly further components 21. The function of the decision system is now explained in detail with regard to FIG. 3 in connection with the description of the inventive method.

FIG. 3 shows an example of a flowchart for the inventive method, with which a user interface should be generated for a specific input and display apparatus 17 and be displayed thereupon.

For this purpose, input data defining at least one procedure to be implemented are initially determined in their entirety in step S1. The input data can include, for example, the spatial position of the apparatus 17 and/or a time information and/or authentication data of a user and/or patient-related data; but further input data are also conceivable. The input data can be determined from the most varied sources, for example from the localization system 18, the devices 19, the apparatuses 17 themselves, from an input of the user or from the server itself, for example from the databank 14 or the electronic patient record 15. How much input data are actually used depends on the acquisition possibilities.

Procedure information is then determined from these input data in step S2 via linking. The procedure information describes the procedure or procedures to be implemented. How many procedures are considered as probable depends significantly on the number and the quality of the input data, For example, for a nurse located in a medicine storage, it can be assumed that the nurse would like to check for the presence of medicines, would like to make a withdrawal or would like note medicines for re-order. However, if the nurse has also read the barcode of a patient or has otherwise input patient data, it can, for example, be learned (extracted) from the patient's patient record that he or she has been prescribed a specific medication and so a procedure is unambiguously defined, namely the withdrawal of this medication for this patient. The spatial position of the apparatus, the user and patient-related data are entered therein as input data.

The procedure information is now used in step S3 in order to generate a user interface based thereon. This user interface is generated such that the user can simply and quickly receive access to all information relevant for the procedure or procedures. In the above example this would be, among other things, the prescribed medication, whether it is currently in stock, and where it is stored. If the procedure to be implemented or the information to be displayed could not be unambiguously determined, the user interface will possibly exhibit a number of selectable options or also sub-options that quickly direct the user to the relevant information.

Furthermore, user-related or procedure-related data from the past also enter into the generation of the user interface. Since a trainable and knowledge-based system 13 is used, such data can be used without problems in order to further optimize the user interface. In particular, the user interface can also include predetermined values for parameters to be set, which parameters were determined based on past data.

The generated user interface can also be adapted to the user. Specific preferences of the user that can be known from past data or from special settings of the user are now taken into account, so that the user interface ideally suited for the specific user (thus work environment) is generated. User-specific data can also already enter into the determination of the procedure to be implemented or the procedure information. For example, it can be detected that a specific physician always conducts his or her visits to patients between seven o'clock and eight o'clock in the morning. If a physician is accordingly located in a patient room at 7:35, it is known to the trainable system 13 (and thus to the information system 11) that the procedure is a patient visit.

Finally, in step S4 the user interface is presented on the input and display apparatus 17 and thus executed. If options are provided, the user can now select one of these. The information is presented on a display device of the apparatus 17.

In order to retain the data of the currently implemented method instance for later evaluation by the trainable and knowledge-based system 13, the input data and/or the procedure information can be stored in the databank 14 together with information about the actual data retrieved by the user.

The trainable and knowledge-based system 13 that is fashioned as a neural network in the exemplary embodiment operates in the learning process with, for example, genetic algorithms and/or statistical analyses and/or Bayesian methods. These known methods in trainable systems need not be presented in detail here.

In the inventive method the user can also himself influence the design of the user interface. It is possible for the generation of the user interface to ensue under consideration of parameters that are predeterminable by the user, meaning that the user can influence the generation process, for example by exclusion of specific information that he or she would not want to have displayed.

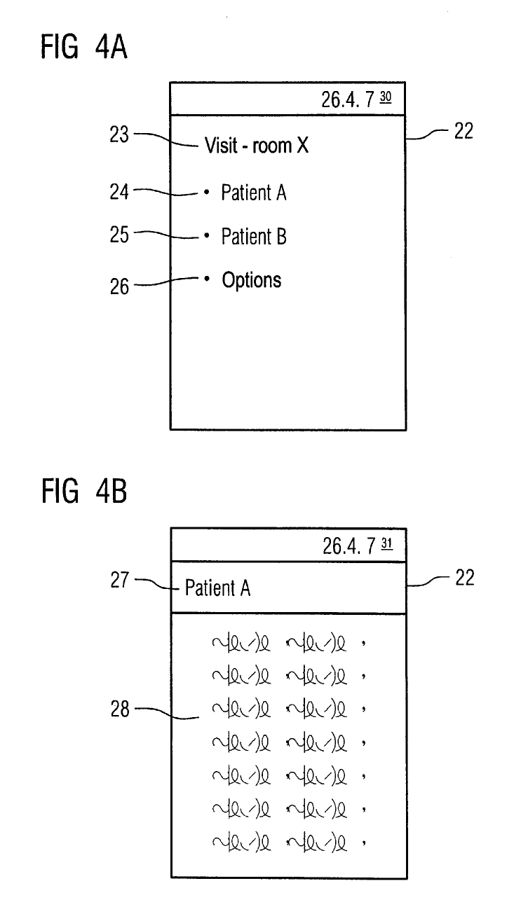

FIGS. 4 through 6 exemplarily show user interfaces generated by means of the inventive method.

FIG. 4A shows a user interface 22 that a physician is shown during his visiting rounds in room X. In the title line it is initially communicated to him that the information system assumes that he is presently at the visit in room X. Two patients, namely patient A and patient B, are located in room X. The physician is the corresponding treating physician for both patients, such that he or she can now select the information of which patient he or she would like to see first under the options 24 and 25. Further options are selectable with the selection 26.

FIG. 4B shows the user interface 22 after patient A (option 24) was selected. The title 27 now indicates that patient A was selected. The items of information from the patient record of the patient A that are relevant for a visit are displayed in a text window 28 below the title 27.

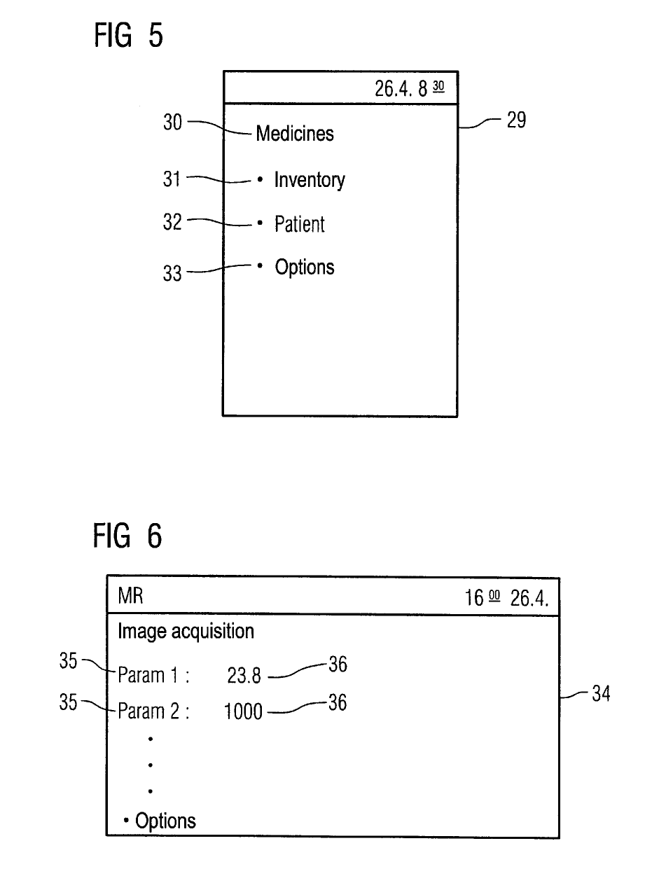

FIG. 5 shows a further user interface 29 as displayed, for example, to a nurse or attendant in a medicine room. The title 30 indicates to the nurse or the attendant that the following options refer to the medications. The inventory of the room can be checked under the option 31. A patient for whom a medication should be administered can be input or scanned in under the option 32. Further options can be selected with the selection 33.

Shown in FIG. 6 is a further user interface 34 as it is displayed, for example, on a stationary input and display apparatus 17 that is associated with a magnetic resonance device. A number of parameters that can be set by the user are visibly designated. Values 36 that could be suitable for the patient B to be acquired based on a consideration of past data are already preset for these parameters. These values 36 were determined by the decision system 13 based on the input data and the following procedure information. Primarily information about symptoms and prior information from the electronic patient record of the patient B are used for this, in addition to the identity of the treating physician and the spatial position of the corresponding input and display apparatus 17. For example, the image acquisition parameters are set so that the region in which a pathological finding is assumed is acquired. The physician can now effect further modifications. These are then possibly used for later user interfaces to be generated.

A method and an information system with which medical personnel can receive the required information quickly, simply and in an uncomplicated manner are encompassed by the invention. For this purpose, it is initially determined which procedure is presently to be implemented, and a user interface is generated based on this procedure information. The relevant information thus can be located quickly and simply at all positions in the treatment path of patients.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for locating and displaying information in an information system of a medical facility having a plurality of input and display apparatuses communicating via a network, comprising the steps of:
for a procedure associated with a patient at the medical facility, entering input data into the information system that define the procedure in its entirety and, in the information system, automatically linking the input data with procedure information;
from said procedure information, automatically generating a displayable user interface that is specific for said procedure; and
displaying the user interface at a stationary or mobile display apparatus via said network.

2. A method as claimed in claim 1 comprising, in said input data, including information selected from the group consisting of a spatial position of the display apparatus and time information.

3. A method as claimed in claim 1 comprising including, in said input data, information selected from the group consisting of authentication data of a user of the display apparatus and patient data from an electronic patient record.

4. A method as claimed in claim 1 comprising entering at least a portion of said input data via an input source selected from the group consisting of a radio system, an electronic card reader, and an RFID chip.

5. A method as claimed in claim 1 comprising entering at least one of said input data and said procedure information into a data bank via said network.

6. A method as claimed in claim 1 comprising generating said user interface in a trainable system that refines said user interface as more input data are received.

7. A method as claimed in claim 6 comprising providing access by said trainable system to historical information selected from the group consisting of historical information related to a user of the display apparatus and historical information relating to said procedure.

8. A method as claimed in claim 6 comprising generating said refined user interface in said trainable system according to an algorithm selected from the group consisting of genetic algorithms, statistical analysis algorithms, and Bayesian algorithms.

9. A method as claimed in claim 6 comprising allowing a user of the display device to enter parameters forming a part of said input data, and including and displaying said parameters in said user interface.

10. A method as claimed in claim 6 comprising generating said refined user interface adapted to a specific user of the display apparatus.

11. A method as claimed in claim 1 comprising including in said input data parameters that are predetermined by a user of the display apparatus.

12. A method as claimed in claim 1 comprising selecting said procedure from the group consisting of admission of the patient, diagnosis of the patient, therapy of the patient, and discharge of the patient.

13. An information system for a medical facility comprising:
a plurality of input apparatuses communicating via a network;
at least one of said input apparatuses allowing, for a procedure associated with a patient at the medical facility, entry of input data into the information system that define the procedure in its entirety;
a processor that automatically links the input data with procedure information and that, from said procedure information, automatically generates a displayable user interface that is specific for said procedure; and
a plurality of stationary or mobile display apparatuses in said medical facility communicating with said network at which said user interface is displayable, said processor, also from said procedure information, selecting at least one of said display apparatuses for display of said user interface.

14. An information system as claimed in claim 13 wherein said processor comprises a trainable system that is trained upon input of an increasing amount of said input data.

15. An information system as claimed in claim 13 comprising a localizer that identifies a location of an input apparatus at which said input data were entered, and that includes said location in said procedure information, and wherein said processor generates said user interface dependent in part on said location in said procedure information and causes said user interface to be displayed at a display apparatus associated with the input apparatus at which the input data were entered.
